(19) United States
(12) Patent Application Publication
(10) Pub. No.: US 2005/0027805 A1
(43) Pub. Date: Feb. 3, 2005

(54) Instant messaging and enhanced scheduling

(76) Inventor: Norihiro Edwin Aoki, Sunnyvale, CA (US)

Correspondence Address: GLENN PATENT GROUP, 3475 EDISON WAY, SUITE L, MENLO PARK, CA, 94025, US

(21) Appl. No.: 10/620,683

(22) Filed: Jul. 15, 2003

(51) Int. Cl. G06F 15/16

(52) U.S. Cl. 709/206; 709/202

(57) ABSTRACT

Instant messaging communications method and apparatus are provided in which one of the parties is not a person but an automated system or agent (bot) that accepts requests and issues responses. The invention provides such a bot, which can be used as an aid to scheduling events and tasks, either alone, or in conjunction with other individuals. The bot is addressable by the user. In one embodiment, a bot appears as an entity on a buddy list. For example, a participant who would like to schedule a meeting initiates a conversation with the bot, which then asks a series of questions to determine the intent of the user. The bot could also initiate instant messaging communications to prospective meeting attendees and mediate a discussion related to the meeting. In another embodiment, the agent or bot is linked to an online calendar service to determine participant availability and after finalizing meeting details, adds such information to the participants' online calendar, as dictated by the capabilities of the calendar application.

### BACKGROUND OF THE INVENTION

1. Technical Field

The invention relates generally to communications. More particularly, the invention relates to a messaging communication system in which one of the parties is an automated system accepting requests and issuing responses.

2. Description of the Prior Art

Instant messaging has taken off as a popular and productive means of communication between interested parties. Variations on the instant messaging system and on instant messaging buddy groups have also been explored.

M. McDowell, J. Khalil, S. Zweifach, G. Stead, and D. JR. LeJeune, Use of Presence and Location Information Concerning Wireless Subscribers for Instant Messaging and Mobile Commerce, U.S. Patent Application Publication No. 2002/0035605 (Mar. 21, 2002) teaches an integrated system enabling instant messaging and mobile commerce as a centralized gateway attached to the networks of a large number of wireless providers. The gateway facilitates a process by which individual wireless carriers enter into bi-lateral agreements with specific Internet content providers. The gateway enables Internet services that require real-time information about wireless subscribers in order to conduct m-commerce or offer advanced messaging services.

M. Aravamudan, R. F. Henrick, R. Sundar, G. Xikes, and J. Gregory, Assignable Associate Priorities for User-Definable Instant Messaging Buddy Groups, U.S. Pat. No. 6,301,609 (Oct. 9, 2001) discloses using features and capabilities associated with instant messaging to locate a registered user, query the user for a proposed message disposition, and coordinate services among a plurality of communication devices, modes, and channels. A user proxy is registered to the user as a personal communication services platform. The user is able to define various rules for responding to received data and communications. The rules are stored within a rules database servicing the communication services platform. Instant messaging is used for communications between the user and the communication services platform's user proxy.

T. Kay and R. Hoffer, Method and System for Interactively Responding to Instant Messaging Requests, U.S. Pat. No. 6,430,602 (Aug. 6, 2002) disclose a method and system for interactively responding to queries from a remotely located user. A computer server system is configured to receive an instant message query or request from the user over the Internet. The query or request is interpreted and appropriate action is taken, such as accessing a local or remote data resource and formulating an answer to the user's query. The answer is formatted as appropriate and returned to the user as an instant message or via another route specified by the user. A method and system of providing authenticated access to a given web page via instant messaging is also disclosed.

L. Bouchard and D. Donaldson, Instant Message Notification Application, PCT Patent Application No. WO 01/43357 (Dec. 4, 2000) disclose a message notification system using technology found in instant messaging services. A user logs onto the instant messaging service and indicates to the message notification application that the user would like to be notified when new messages arrive. The message notification application then adds the user to its own buddy list. The user is notified by the message notification application through the instant messaging service when a message is received. The user can then retrieve messages through an internet appliance with sound capabilities, or by using voice-to-text conversion capabilities of the application.

However, none of the prior art teachings above provide an automated mechanism using instant messaging technology to improve end user productivity by providing an interactive form of data entry.

It would be advantageous for a portal system to integrate core product offerings, such as an instant messaging system with other offered services, such as scheduling and calendaring systems to leverage existing technologies for end users.

It would further be advantageous to provide an automated system and process that uses a conversational model as a mechanism for inputting data into a backend system and/or as an outbound confirmation mechanism.

It would further be advantageous to provide an interface for automatically interacting with back-end processes, such as a calendar.

### SUMMARY OF THE INVENTION

Instant messaging communications method and apparatus are provided in which one of the parties is not a person but an automated system or agent (bot) that accepts requests and issues responses. The invention provides such a bot, which can be used as an aid to scheduling events and tasks, either alone, or in conjunction with other individuals. The bot is addressable by the user. In one embodiment, a bot appears as an entity on a buddy list. For example, a participant who would like to schedule a meeting initiates a conversation with the bot, which then asks a series of questions to determine the intent of the user. The bot could also initiate instant messaging communications to prospective meeting attendees and mediate a discussion related to the meeting. In another embodiment, the agent or bot is linked to an online calendar service to determine participant availability and after finalizing meeting details, adds such information to the participants' online calendar, as dictated by the capabilities of the calendar application.

### BRIEF DESCRIPTION OF THE DRAWINGS

FIG. 1 is a high level schematic diagram of the main components of a first embodiment according to the invention; and

FIG. 2 is a high level schematic diagram of the main components of a second embodiment according to the invention.

### DETAILED DESCRIPTION OF THE INVENTION

Instant messaging communications method and apparatus are provided in which one of the parties is not a person but an automated system or agent (bot) that accepts requests and issues responses. The invention provides such a bot, which can be used as an aid to scheduling events and tasks, either alone, or in conjunction with other individuals. The bot is addressable by the user. In one embodiment, a bot appears as an entity on a buddy list. For example, a participant who would like to schedule a meeting initiates a conversation with the bot, which then asks a series of questions to determine the intent of the user. The bot could also initiate instant messaging communications to prospective meeting attendees and mediate a discussion related to the meeting. In another embodiment, the agent or bot is linked to an online calendar service to determine participant availability and after finalizing meeting details, adds such information to the participants' online calendar, as dictated by the capabilities of the calendar application.

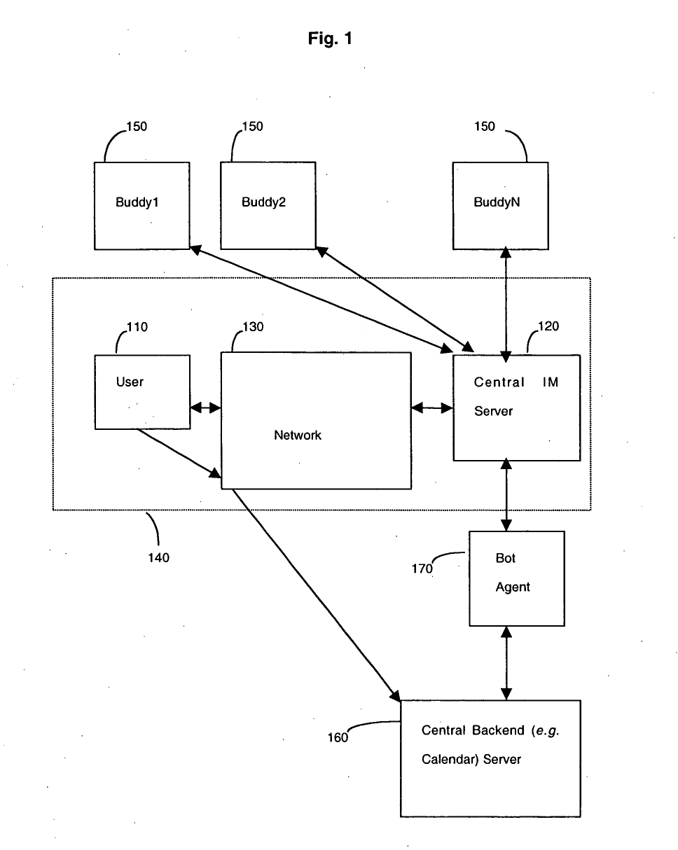

A first embodiment of the invention is discussed with reference to FIG. 1, a schematic diagram of the main components according to the invention. A messaging client 110 (user) exchanges messages via a network 130, such as the Internet, with a messaging server 120. The messaging client 110 and messaging server 120 communicate using a protocol that is mutually understood between the two entities. The combination of the messaging client 110, messaging server 120, and the protocol is referred to as a messaging system 140.

Examples of Messaging Systems

Messaging systems of the preferred embodiment of the invention can be, but are not limited to, two-way messaging systems, also referred to as real-time messaging systems. Some types of such messaging systems are: email (one-way or two-way in non-real-time); a paging network (one-way or two-way in near-real-time); and instant messaging systems (two-way, in real-time). Specific examples of such messaging systems comprise: AOL's AIM, Microsoft Messenger, Yahoo! Messenger, and Short Message Service (SMS).

It should be appreciated that the messaging server 120 can also be coupled to a plurality of other clients, such as 1-n online buddies 150.

The invention provides a method and apparatus for interfacing a messaging system with a backend system through the automated (bot) agent. For example, in one implementation of the preferred embodiment, the method and apparatus provides means for interfacing the messaging system 140 with an online calendar system 160 through the use of a calendar bot agent 170. It should be appreciated that the calendar bot agent 170 may take a variety of forms, such as, but not limited to an addressable destination in the case of an email, paging, or SMS-based messaging system, or a “buddy” in the case of an instant messaging system. The calendar bot agent 170 receives messages passed from the messaging system, parses such messages, and provides instructions to manipulate a user's online calendar, represented in FIG. 1 as residing on a calendar system server 160.

It should further be appreciated that the backend server 160, e.g. the calendar server, also maintains the user's informational data, such as maintaining the user's online calendar data.

It should be appreciated that a user 110 may choose to access the user's backend system 160, e.g. calendar system, directly via a client, Web-based interface, or other means known to one skilled in the art. Because informational data is kept centrally at the backend system 160, the user 110 is able to view the same informational data, such as for example an agenda.

Example Calendar Systems

A preferred embodiment of the invention uses a messaging system to manipulate entries in a preexisting online calendar system. Examples of such calendar systems are AOL online calendar and LAN-based calendar services, such as Microsoft Outlook, Oracle Corporate Time, and Lotus Notes.

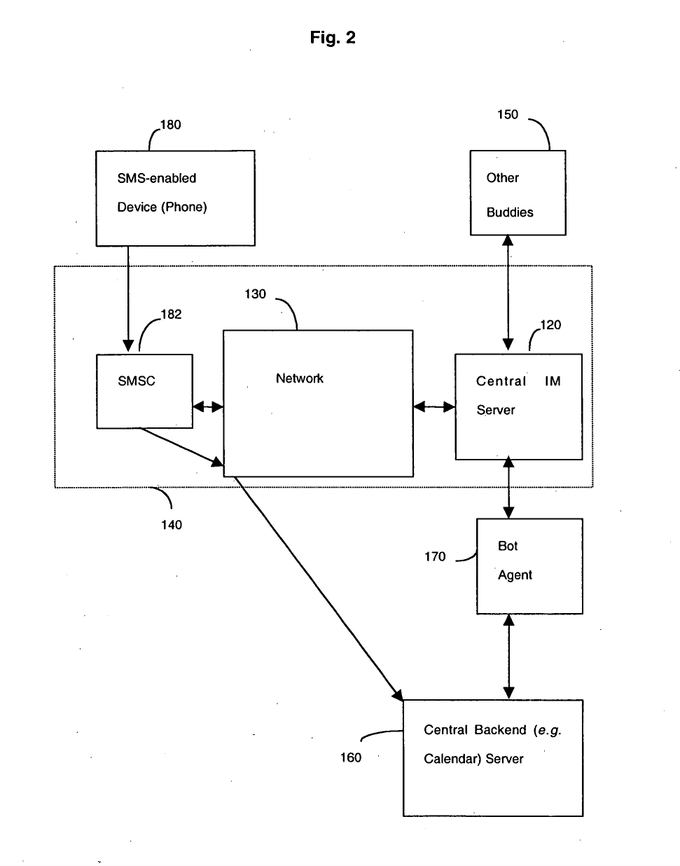

A second example implementation can be discussed with reference to FIG. 2. FIG. 2 shows an SMS-enabled client 180 and SMSC gateway 182 interfacing with the central IM server 120 via the network 130. In FIG. 2, the SMS device 180 connects to an SMSC (gateway) 182 which converts SMS messages to those understandable by the central IM server 120.

In another embodiment of the invention, the SMSC gateway 182 is able to exchange messages directly with the backend server160, such as the calendar server, bypassing the central IM server 120 altogether.

An Example Conversation between an End User and a Bot Agent

Following is an example conversation between an end user and a calendar agent according to the invention.
The end user initiates addressing a message to the calendar agent using whatever means provided by the messaging system. Such means may comprise, for example, choosing the calendar agent from a buddy list or addressing an email to a specific address;
The message contains instructions to the calendar agent to manipulate the user's online calendar, for example, to schedule a meeting;
In the case of a two-way messaging system, the calendar agent may respond to the end user with information, confirmation, or with a request for additional information. In the case where additional information is requested, the end user returns to the first step and provides such information to the calendar agent.

It should be appreciated that the dialog between the bot agent and the end user may take a variety of forms, comprising following a specific syntax, e.g. “11-01-2002 4 pm conference call,” or being conversational in nature, for example, through the use of free-flowing natural language processing. The dialog can also take the form of form filling, as in SMS messaging

It should be further appreciated that the bot agent may proactively send messages to the end user, for example, a reminder for an event. However, it should be noted that while the bot agent is capable of proactively initiating communications to the end user (such as alerting and notification) for performing certain tasks, the bot agent isn't limited to being merely reactive. The bot agent is capable of accepting new data. For example, the bot agent has the capability of accepting new calendar entries.

Example Scenario

A bot appears as an entity on a buddy list, such as with screenname “ScheduleBot”. The end user wants to schedule a meeting and simply addresses a conversation to ScheduleBot. ScheduleBot asks a series of questions to determine the intent of the end user. ScheduleBot could also initiate IM communications to prospective meeting attendees and mediate a discussion related to the meeting. In one scenario, ScheduleBot is linked to an online calendar service so that it is able to determine participant and/or resource availability. After finalizing meeting details, ScheduleBot injects such resulting information about the meeting into the end user's online calendar.

A sample conversation, including calendar integration, appears below in Table A, with end user input from screenname “End User” to ScheduleBot preceded with a‘>’character, and corresponding output from ScheduleBot indicated by a preceding ‘<’character.

TABLE A
> Hello
< Hello End User. How can I help you today (type ‘help’ to learn more
about what I can do)
> Schedule a meeting
< Ok. What day would you like to have the meeting?
> Tuesday
< Ok. Tuesday, July 16. What is the title of the meeting?
> Design stuff
< Who else will be at this meeting?
> Buddy1, Buddy2
[ScheduleBot checks the online calendars for End User, Buddy1, and
Buddy2 at this point, assuming that Buddy1 and Buddy2 have authorized
ScheduleBot (on behalf of End User) to do so]
< Ok. On Tuesday, July 16, the only times when you, Buddy1, and
Buddy2 are free are 9:00-10:00 am and 4:30-5:15 pm.
< When would you like to have the meeting?
> 4:30-5:00
< Ok. I've scheduled a meeting on “Design stuff” for the three of you at
4:30 pm on Tuesday, July 16. Would you like to add any resources to this
meeting, such as a conference room or dial-in number?
> No
< Alright, you're all set. Good bye.

Example Confirmation 1

Additionally, in the dialog example above, while ScheduleBot was checking calendars or after scheduling the meeting, ScheduleBot could have made a request to Buddy1, assuming Buddy1 is online, and asked:
>Hi. End User wants to schedule a meeting with you on Design stuff on Tuesday. Shall I go ahead?
   Example Confirmation 2

Following is an example when the confirmation is after the fact:
>Hi. End User has scheduled a meeting with you on Design stuff on Tuesday. You do not have a conflict at this time. Would you like to accept?
<Yes
>Ok, thanks.

At this point, ScheduleBot marks the meeting as confirmed for Buddy1.

Again, in the examples above, how an event is actually scheduled is determined and implemented by the particular calendaring server.

Accordingly, although the invention has been described in detail with reference to particular preferred embodiments, persons possessing ordinary skill in the art to which this invention pertains will appreciate that various modifications and enhancements may be made without departing from the spirit and scope of the claims that follow.

1. An apparatus for manipulating data in a backend system using an automated agent, said apparatus comprising:
a messaging client for exchanging messages over a network with a messaging server;
said automated agent, wherein said automated agent is coupled to said messaging server; and
said backend system, wherein said backend system is coupled to said automated agent.

2. The apparatus of claim 1, wherein said automated agent is capable of accepting requests and issuing responses.

3. The apparatus of claim 1, wherein said automated agent obtains and uses input data from a plurality of other entities coupled to said messaging server for helping to determine said manipulation of data.

4. The apparatus of claim 3, wherein said automated agent initiates messaging communications to said plurality of other entities and mediates a discussion related to said input data.

6. The apparatus of claim 1, wherein said automated agent appears as a buddy on a buddy list.

6. The apparatus of claim 1, wherein said automated agent initiates messaging communications to prospective meeting attendees and mediates a discussion related to said meeting.

7. The apparatus of claim 1, wherein said automated agent is capable of responding with any of, but not limited to: information, confirmation, availability, and a request for additional information.

8. The apparatus of claim 1, wherein said messaging client exchanges messages via said network with said messaging server by any of, but not limited to:
two-way messaging in real-time and/or non-real-time;
email in real-time and/or non-real-time;
a paging network in one-way and/or two-way in near-real-time; and
instant messaging systems in two-way in real-time.

9. The apparatus of claim 1, wherein said automated agent received messages passed from said messaging server and parses said messages.

10. The apparatus of claim 1, wherein said backend system maintains informational data of said messaging client, and said messaging client is capable of accessing said informational data directly.

11. The apparatus of claim 1, wherein said messaging client engages in a dialog with said automated agent.

12. The apparatus of claim 1, wherein said automated agent performs any of:
proactively sending messages to said messaging client, said messages comprising, but not limited to alerting and reminders;
asking a series of questions to said messaging client to determine intent; and
determining resource availability.

13. A method for manipulating data in a backend system using an automated agent, said method comprising:
providing a messaging client for exchanging messages over a network with a messaging server;
providing said automated agent, wherein said automated agent is coupled to said messaging server; and
providing said backend system, wherein said backend system is coupled to said automated agent.

14. The method of claim 13, wherein said automated agent is capable of accepting requests and issuing responses.

15. The method of claim 13, wherein said automated agent obtains and uses input data from a plurality of other entities coupled to said messaging server for helping to determine said manipulation of data.

16. The method of claim 15, wherein said automated agent initiates messaging communications to said plurality of other entities and mediates a discussion related to said input data.

17. The method of claim 13, wherein said automated agent appears as a buddy on a buddy list.

18. The method of claim 13, wherein said automated agent initiates messaging communications to prospective meeting attendees and mediates a discussion related to said meeting.

19. The method of claim 13, wherein said automated agent is capable of responding with any of, but not limited to: information, confirmation, availability, and a request for additional information.

20. The method of claim 13, wherein said messaging client exchanges messages via said network with said messaging server by any of, but not limited to:
two-way messaging in real-time and/or non-real-time;
email in real-time and/or non-real-time;
a paging network in one-way and/or two-way in near-real-time; and
instant messaging systems in two-way in real-time.

21. The method of claim 13, wherein said automated agent received messages passed from said messaging server and parses said messages.

22. The method of claim 13, wherein said backend system maintains informational data of said messaging client, and said messaging client is capable of accessing said informational data directly.

23. The method of claim 13, wherein said messaging client engages in a dialog with said automated agent.

24. The method of claim 13, said automated agent performing any of:
proactively sending messages to said messaging client, said messages comprising, but not limited to alerting and reminders;
asking a series of questions to said messaging client to determine intent; and
determining resource availability.
